(19) United States
(12) Patent Application Publication
(10) Pub. No.: US 2019/0057154 A1
(43) Pub. Date: Feb. 21, 2019

(54) Token Metadata for Forward Indexes on Online Social Networks

(71) Applicant: Facebook, Inc., Menlo Park, CA (US)

(72) Inventors: Rose Marie Philip, Sunnyvale, CA (US); Giuseppe Ottaviano, San Francisco, CA (US); Daniel Bernhardt, London (GB)

(21) Appl. No.: 15/680,096

(22) Filed: Aug. 17, 2017

(51) Int. Cl. G06F 17/30; G06F 17/27

(52) U.S. Cl. CPC G06F 17/30867; G06F 17/30684; G06F 17/273; G06F 17/277; G06F 17/30696

(57) ABSTRACT

In one embodiment, a method includes receiving a search query, searching a reverse index to identify one or more objects having one or more tokens that match the search query, and accessing a forward index that has several records that each correspond to an object posted to an online social network. Each record may comprise a first field of tokens, and one or more second fields corresponding to metadata associated with each of the tokens. The method may further include scoring each identified object based on its respective record. The score for each identified object may be calculated based on the metadata associated with each of the tokens. The method may also include sending, to the client system in response to the received search query, instructions for presenting one or more search results corresponding to the identified objects having a score greater than a threshold score.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may use metadata associated with content posted to the online social network to improve the ranking process for search results. The metadata may be stored in association with a forward index. When textual content is posted to the online social network, the social-networking system may parse the text into tokens (e.g., words). As an example and not by way of limitation, the post, “This is AT&T” may be parsed into the following tokens: this, is, at, &, t, att. These tokens may be stored in a record in a forward index associated with the post. The last four tokens may have been created from the n-gram “AT&T” in the post. These may be referred to as modified tokens, because they are tokens that do not appear as individual terms in the original post. Modified tokens may be created to capture all variants of a term that a user may search. For example, a user may search “att” or just “at,” intending to locate AT&T (either the entity AT&T, or some other plurality of entities “AT” and “T”). The social-networking system may use modified tokens to provide accurate search results in situations where a querying user's search query does not exactly match the n-grams in the post she wishes to locate.

In particular embodiments, tokens may be associated with metadata that describe various characteristics about the tokens and the original text. Examples of metadata may include an indication that the token is modified, an indication that the token is part of a larger n-gram in the original post, an indication that the term was capitalized in the original post, or any other suitable information. The social-networking system may use the metadata to calculate a more accurate score for search results generated in response to a search query. Both the tokens and the metadata may be stored in a record that corresponds to a particular post. The tokens may be stored in a first field of the record and the metadata may be stored in one or more second fields (e.g., each type of metadata may be stored in a single second field). When the social-networking system receives a search query and identifies a set of search results comprising a plurality of posts, the social-networking system may access the record corresponding to each identified post and calculate a score for each identified post that is based at least in part on the metadata associated with each of the tokens that match an n-gram of the search query.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example content object posted to an online social network.

FIG. 4 illustrates an example visualization for generating modified tokens for example text in an example content object.

FIG. 5 illustrates an example method 500 for using metadata associated with content posted to the online social network to improve the ranking process for search results.

FIG. 6 illustrates an example computer system.

### DESCRIPTION OF EXAMPLE EMBODIMENTS

### System Overview

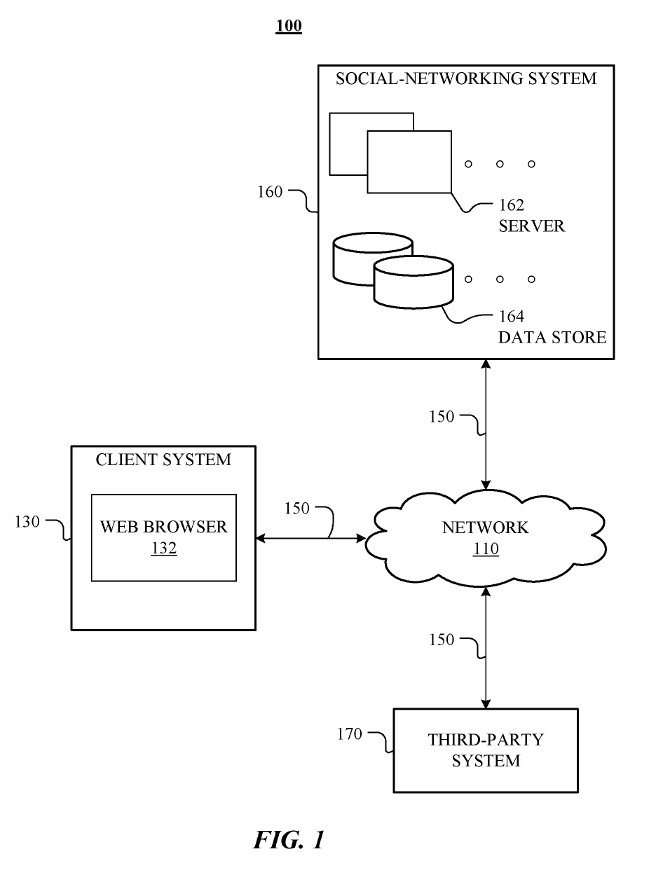

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

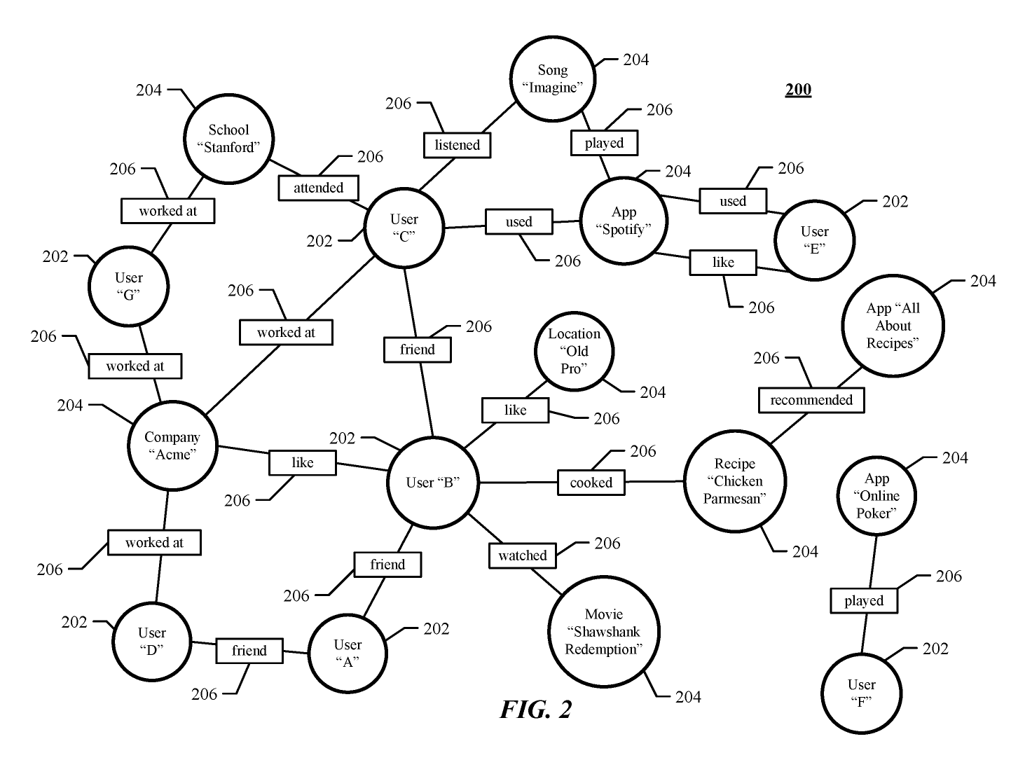

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763,162, filed 19 Apr. 2010, and U.S. patent application Ser. No. 13/556,072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556,072, filed 23 Jul. 2012, U.S. patent application Ser. No. 13/731,866, filed 31 Dec. 2012, and U.S. patent application Ser. No. 13/732,101, filed 31 Dec. 2012, each of which is incorporated by reference. More information on structured search queries and grammar models may be found in U.S. patent application Ser. No. 13/556,072, filed 23 Jul. 2012, U.S. patent application Ser. No. 13/674,695, filed 12 Nov. 2012, and U.S. patent application Ser. No. 13/731,866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244,748, filed 3 Apr. 2014, U.S. patent application Ser. No. 14/470,607, filed 27 Aug. 2014, and U.S. patent application Ser. No. 14/561,418, filed 5 Dec. 2014, each of which is incorporated by reference.

Token Metadata for Forward Indexes

In particular embodiments, the social-networking system 160 may use metadata associated with content posted to the online social network to improve the ranking process for search results. The metadata may be stored in association with a forward index. When textual content is posted to the online social network, the social-networking system 160 may parse the text into tokens (e.g., words). As an example and not by way of limitation, the post, “This is AT&T” may be parsed into the following tokens: this, is, at, &, t, att. These tokens may be stored in a record in a forward index associated with the post. The last four tokens may have been created from the n-gram “AT&T” in the post. These may be referred to as modified tokens because they are tokens that do not appear as individual terms in the original post. Modified tokens may be created to capture all variants of a term that a user may search. For example, a user may search “att” or just “at,” intending to locate AT&T (either the entity AT&T, or some other plurality of entities “AT” and “T”). The social-networking system 160 may use modified tokens to provide accurate search results in situations where a querying user's search query does not exactly match the n-grams in the post she wishes to locate.

In the context of ranking search results, modified tokens may cause problems in at least two situations: (1) when a querying user enters a search query that includes multiple terms that match the modified tokens associated with a post she does not wish to locate, and (2) when intervening positions between unmodified tokens are filled with modified tokens. An example of the first situation may be a search query that states “at att,” where the querying user intends to locate a post a friend had posted that said “Hanging out at the AT&T Store.” The social-networking system 160 may rank the post “This is AT&T” higher than the post “Hanging out at the AT&T Store” because “at” and “att” are both tokens for the post “This is AT&T,” and the post “This is AT&T” has a larger proportion of tokens in common with “at att” than does the post “Hanging out at the AT&T Store.” However, up-ranking the “This is AT&T” post, which is being retrieved because the query matches the modified tokens, leads to lower quality search results being returned to the user. An example of the second situation may be the post “This is AT&T.” This post may correspond to a record with tokens <this, is, at, &, t, and att>, which may occupy positions <0, 1, 2, 3, 4, and 5> in a corresponding record. If a user enters a search query that says, “This is ATT,” the social-networking system 160 may erroneously rank the post “This is AT&T” lower than it should because posts with tokens positioned close together in the forward index may be ranked higher than words positioned farther away from each other. Thus, although the search query “This is ATT” is a very close match to the post “This is AT&T,” the social-networking system 160 may look at the positions of the tokens in the forward index and see that in the search query, “This” corresponds to the token at position 0, “is” corresponds to the token at position 1, and “ATT” corresponds to the token at position 5. Since there are three intervening tokens between position 1 and 5, the social-networking system 160 may rank the post lower than it would if all three words corresponded to tokens in consecutive positions. But that may be a mistake—“This is ATT” does correspond to terms in the post in consecutive positions, so it should be ranked relatively high. But because of the way modified terms are indexed in the forward index, the corresponding token positions may not be consecutive. To overcome these and other problems, the social-networking system may use one or more types of metadata in association with modified and unmodified tokens to generate more accurate search results.

In particular embodiments, tokens may be associated with metadata that describe various characteristics about the tokens and the original text. Examples of metadata may include an indication that the token is modified, an indication that the token is part of a larger n-gram in the original post, an indication that the n-gram corresponding to the token was capitalized in the original post, or any other suitable information. The social-networking system 160 may use the metadata to calculate a more accurate score for search results generated in response to a search query. Both the tokens and the metadata may be stored in a record that corresponds to a particular post. The tokens may be stored in a first field of the record and the metadata may be stored in one or more second fields (e.g., each type of metadata may be stored in a single second field). When the social-networking system 160 receives a search query and identifies a set of search results comprising a plurality of posts, the social-networking system 160 may access the record corresponding to each identified post and calculate a score for each identified post that is based at least in part on the metadata associated with each of the tokens that match an n-gram of the search query.

In particular embodiments, the social-networking system 160 may receive, from a client system 130 associated with a user of the online social network, a search query comprising one or more n-grams. The search query may have been inputted manually by the user or may have been selected from a list of search query options (e.g., in a typeahead interface). The search query may comprise any number or combination of n-grams related to any topic. As an example and not by way of limitation, the social-networking system 160 may receive a search query that states, “Bass fishing in Michigan.” As another example and not by way of limitation, the social-networking system 160 may receive a search query that states, “This is ATT.” Although this disclosure describes receiving particular search queries in a particular manner, this disclosure describes receiving any suitable search queries in any suitable manner.

In particular embodiments, social-networking system 160 may parse an search query received from the first user (i.e., the querying user) to identify one or more n-grams. In general, a n-gram is a contiguous sequence of n items from a given sequence of text or speech. The items may be characters, phonemes, syllables, letters, words, base pairs, prefixes, or other identifiable items from the sequence of text or speech. The n-gram may comprise one or more characters of text (letters, numbers, punctuation, etc.) entered by the querying user. Each n-gram may include one or more parts of the text query received from the querying user. In particular embodiments, each n-gram may comprise a character string (e.g., one or more characters of text) entered by the first user. As an example and not by way of limitation, social-networking system 160 may parse the text query “usa germany” to identify the following n-grams: usa; germany; usa germany.

In particular embodiments, a search-query processor may generate a query command that includes one or more query constraints in conjunction with the n-grams of the search query. As an example and not by way of limitation, the query constraints may involve matching the n-grams of the search query to the tokens of the user-inputted content fields or the tokens of the third-party content fields. For example, a search query for the n-grams “usa germany” may be expressed as “and (11x.textusa 11x.text:germany),” where “11x.text” queries the field corresponding to the tokens of textual content of the post of the forward index. The search-query processor may further expand the search query to include multiple fields of the forward index. As an example and not by way of limitation, an expanded search query may be expressed as “and ((11x.text:usa inner.text:usa) or (11x.text:germany inner.text:germany)),” where “inner.text” queries the field corresponding to the tokens for the embedded article. Although this disclosure describes parsing and generating particular queries in a particular manner, this disclosure contemplates parsing and generating any suitable queries in any suitable manner. More information on indices and search queries may be found in U.S. patent application Ser. No. 13/560,212, filed 27 Jul. 2012, U.S. patent application Ser. No. 13/560,901, filed 27 Jul. 2012, U.S. patent application Ser. No. 13/723,861, filed 21 Dec. 2012, U.S. patent application Ser. No. 13/877,049, filed 3 May 2013, U.S. patent application Ser. No. 13/789,0052, filed 8 May 2013, U.S. patent application Ser. No. 14/341,148, filed 25 Jul. 2014, U.S. patent application Ser. No. 14/609,084, filed 29 Jan. 2015, and U.S. patent application Ser. No. 14/640,461, filed 6 Mar. 2015, each of which is incorporated by reference.

In particular embodiments, the social-networking system 160 may index content objects in one or more search indices. In particular embodiments, information of the content objects may be organized in a search index having an reverse index and a forward index. A reverse index and a forward index may be organized into a number of records or entries, and each record of the reverse index or forward index may include one or more fields populated with data (e.g., tokens) or metadata (e.g., an indication that a token has been modified from the original n-gram to which it corresponds) of the content object, and a field populated with the identifier of the content object, as described below. In a case where the content objects are posts, a record in the reverse index or a forward index for the post may have a field that is populated with a token (e.g., a word) associated with the content of the post and an additional field with the identifier of one or more posts that contains the token, thereby indicating that the particular token associated with the content of the post is contained within the post. As an example and not by way of limitation, a reverse index or forward index record for the token “apple” may be expressed as “apple: 400, 9876, 54321, 6565,” where “apple” is a token associated with the content of one or more posts, and 400, 9876, 54321, 6565 are the identifiers for the posts with content that includes the word “apple.” In particular embodiments, the fields of a reverse index or forward index may include data or metadata and content object identifiers that are associated with the data or metadata.

In particular embodiments, the social-networking system 160 may search a reverse index to identify objects that have tokens that match at least some of the n-grams of the search query. A reverse index (also referred to as an “inverted index”) may be a data structure that stores a mapping from content, such as words or n-grams, to a location of the content from which the mapping originated. As an example and not by way of limitation, the social-networking system 160 may receive a search query that states, “ken m troll.” In response, the social-networking system 160 may search a reverse index for n-grams that match the search query. Each matching n-gram in the reverse index may indicate objects (and corresponding object identifiers) that contain the matching n-gram. Once objects matching each n-gram have been identified, an intersect of these objects can be determined to identify objects that match all of the n-grams. As an example and not by way of limitation, the social-networking system 160 may search a reverse index for objects that match the n-grams “ken,” “m,” and “troll.” The social-networking system 160 may identify an article posted by Vox Magazine that is titled “The world's greatest internet troll explains his craft” as matching all three n-grams. This article may be referred to as a content object (or simply an “object”). The article, along with several other content objects, may be indexed in a forward index. Although this disclosure describes searching a reverse index in a particular manner, this disclosure contemplates searching a reverse index in any suitable manner.

In particular embodiments, the social-networking system 160 may access a forward index that stores the identified content objects. In particular embodiments, the identified content objects may all be stored on the same forward index, or the identified content objects may be stored on different forward indexes. In addition to storing content objects, the forward index may store a plurality of records that correspond to a plurality of objects, respectively. Each object may have a unique object identifier (ID), which can be used to look up the associated record in the forward index. For example, continuing with the prior example, in response to identifying the Vox Magazine article as matching the query “ken m troll” using a reverse index, the social-networking system 160 may use the object ID for the article to search a forward index for a record corresponding to the article. A record for a given content object may comprise a table of information related to the content object. In particular embodiments, each record may comprise a first field and one or more second fields. The first field may correspond to “tokens” associated with the associated content object. The second fields may correspond to one or more types of metadata associated with each of the tokens. A token may be a term identified or created by the social-networking system 160 that is related to the n-grams in the corresponding content object. As an example and not by way of limitation, a user may post a photo to the online social network and may also provide the following text: “Drinking Coca Cola's drink at at&t.” Although this disclosure describes accessing a forward index in a particular manner, this disclosure contemplates accessing a forward index in any suitable manner.

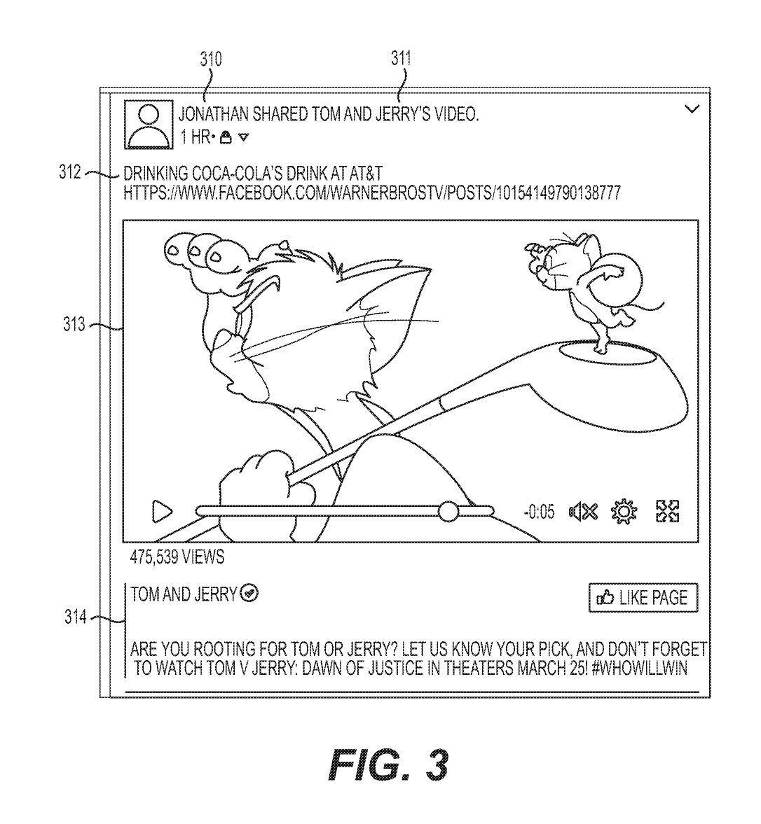

FIG. 3 illustrates an example content object 300 that a user has posted to the online social network. The content object 300 illustrated in FIG. 3 is a post by a first user “Jonathan” sharing a post by a second user “Tom and Jerry.” The content object 300 may comprise a name of a first author of the post 310, a name of a second author of the shared post 311, text-in-post 312 from the shared post that may have been composed by the second author, an image 313 from the shared post, and text from the post 314 that may have been composed by the first author. In this example, the text-in-post 312 from the shared post is “Drinking coca-cola's drink at at&t,” which is text composed by the second user “Tom and Jerry.” This text-in-post 312 comprises a plurality of n-grams. In particular embodiments, the social-networking system 160 may store this post in a forward index along with a record corresponding to the post. The record, as mentioned previously, may comprise a first field that corresponds to tokens that come from the n-grams of the text-in-post 312. In this example, the social-networking system 160 may populate the first field with the following tokens: “Drinking,” “coca,” “cola's,” “drink,” “at,” “at&t.” These six tokens may be taken directly from the n-grams of the content object. Since these tokens exactly match the n-grams of the text-in-post 312, they may be referred to as unmodified tokens.

In particular embodiments, the social-networking system 160 may generate one or more modified tokens that are related to the n-grams, but are not exact matches. As an example and not by way of limitation, three modified tokens may be generated from the n-gram cola's: “colas,” “cola,” and “s.” Four modified tokens may be generated from the n-gram “at&t:” “at,” “&,” “t,” and “att.” These are modified tokens because they do not appear as independent terms in the original text of the content object. In particular embodiments, at least some of the modified tokens may match at least some of the n-grams in the search query. As an example and not by way of limitation, the search query may be “This is att” and the record corresponding to the post of FIG. 3 may have a modified token “att” that matches the n-gram “att” in the search query. The unmodified and modified tokens may all be listed in the first field of the record that corresponds to this content object. Although this disclosure discloses generating modified tokens in a particular manner, this disclosure contemplates generating modified tokens in any suitable manner.

In particular embodiments, the first field may comprise n positions corresponding to n tokens extracted from the user-inputted content of the object corresponding to the record. The n tokens may be positioned in positions 1 through n based on the text in the content object. As an example and not by way of limitation, the tokens in the example post, “Drinking coca cola's drink at at&t,” may be those in the following table:

TABLE 1
Token Position

| Pos. | Token |
|---|---|
| 0 | drinking |
| 1 | coca |
| 2 | cola's |
| 3 | colas |
| 4 | cola |
| 5 | s |
| 6 | drink |
| 7 | at |
| 8 | at |
| 9 | & |
| 10 | t |
| 11 | at&t |
| 12 | att |

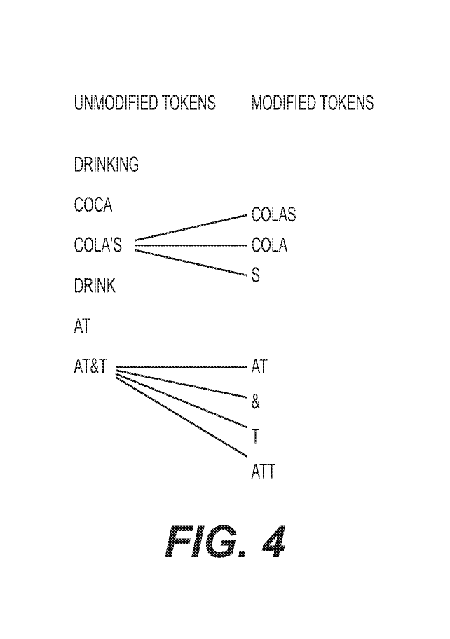

In the above table, tokens in positions 0, 1, 2, 6, 7, and 11 are considered unmodified tokens, which means the character string in the original content object is identical to the character string of the token (aside from changing uppercase letters to lowercase). The other tokens have been modified. FIG. 4 illustrates an example visualization for generating modified tokens for example text in an example content object. In FIG. 4, three modified tokens have been generated from the n-gram “cola's”: “colas,” “cola,” and “s.” Four modified tokens have been generated from the n-gram “at&t”: “at,” “&,” “t,” and “att.” These are modified tokens because they do not appear as independent terms in the original text of the content object. In particular embodiments, the position of the tokens may be based on the position of the text in the content object. As an example and not by way of limitation, because “drinking” appears before “at&t” in the example content object, the token “drinking” may be positioned above the token “at&t” in the table corresponding to the content object 300. Although this disclosure describes populating a first field with tokens in a particular manner, this disclosure contemplates populating a first field in any suitable manner.

In particular embodiments, the social-networking system 160 may generate a modified token based on several factors, including alternative spelling of a particular word, an entity associated with the social-networking system 160, or other variations of an n-gram. As an example and not by way of limitation, a post may include the n-gram “Tom Cruz.” The social-networking system 160 may generate at least two modified tokens based on this n-gram: “tom cruise,” the actor and star of Mission Impossible, and “ted cruz,” the senator and presidential hopeful. As another example and not by way of limitation, a post may include the n-gram “In-N-Out.” The social-networking system 160 may generate at least two modified tokens based on this n-gram: “innout,” which has the hyphens removed, and “in n out,” which replaces the hyphens with spaces. The principle here is that the social-networking system 160 may attempt to create tokens for common variations in spelling for terms and phrases. Although this disclosure describes generating modified tokens in a particular manner, this disclosure contemplates generating modified tokens in any suitable manner.

In particular embodiments, the one or more second fields may each correspond to a type of metadata associated with each of the tokens in the first field. Each type of metadata may be a binary indication of characteristics about the token with which it is associated. The binary indications may be expressed as a “1” or a “0” in the record. Example types of metadata may include whether the token is a modified token, whether the token is the first version of a particular term, whether the token is part of a larger term, whether the token is the last n-gram in a larger term, whether the token is associated with a hashtag, whether the token is capitalized in the original post, or any other suitable information. Although this disclosure describes particular types of metadata being associated with tokens, this disclosure contemplates any suitable metadata being associated with tokens.

In particular embodiments, and as previously discussed, one of the types of metadata may be an indication that a token is a modified token. As an example and not by way of limitation, three modified tokens may be generated from the n-gram “cola's”: “colas,” “cola,” and “s.” Four modified tokens may be generated from the n-gram “at&t”: “at,” “&,” “t,” and “att.” These are modified tokens because they do not appear as independent terms in the original text of the content object. The metadata associated with each of these modified tokens may indicate that they are modified. As an example and not by way of limitation, the record may comprise a “1” in the same row as each of the modified tokens. Although this disclosure describes providing metadata for modified tokens in a particular manner, this disclosure contemplates providing metadata for modified tokens in any suitable manner.

In particular embodiments, one of the types of metadata may be an indication that the token is not the first version of a particular term or n-gram. As discussed previously, the social-networking system 160 may generate one or more modified tokens for a particular n-gram. As an example and not by way of limitation, a post may include the n-gram “Tom Cruz.” The social-networking system 160 may generate at least two modified tokens based on this n-gram: “tom cruise,” and “ted cruz.” The record may comprise three tokens: the token corresponding to the original text of the post, “Tom Cruz,” and the two modified tokens. The second field may comprise a space for indicating that the token is not the first version. In this second field for the “tom cruz” token, there may be a “0,” because this token is the first version of the n-gram. In each of the second fields for “tom cruise” and “ted cruz,” there may be a “1,” because those tokens are not the first version of the n-gram (they are modified tokens, so they are subsequent versions). Although this disclosure describes providing metadata in a particular manner, this disclosure contemplates providing metadata in any suitable manner.

In particular embodiments, one of the types of metadata may be an indication that the token corresponds to a term that continues. That is, the metadata may indicate that a first token is part of an n-gram that terminates with a second token. As an example and not by way of limitation, for the post, “Drinking Coca Cola's drink at at&t,” the social-networking system 160 may generate the following tokens for the n-gram “at&t:” “at,” “&,” and “t.” The record may comprise a second field with metadata indicating that a first token is part of an n-gram that terminates with a second token. Thus, since this particular “at” token does not correspond to the end of the n-gram of which it is a part, the second field may comprise a “1” for this token. There may also be a “1” for the token “&.” Next to the token “t” there may be a “1,” because the term “at&t” terminates with “t.” As an example and not by way of limitation, the record comprising the first field and the second fields may be similar to the following table:

TABLE 2
Tokens and Example Metadata

| | | | 2. Is the token | 3. Does the |
|---|---|---|---|---|
| | | 1. Is the token | not the first | term |
| Pos. | Token | modified? | version? | continue? |
| 0 | drinking | 0 | 0 | 0 |
| 1 | coca | 0 | 0 | 0 |
| 2 | cola's | 0 | 0 | 0 |
| 3 | colas | 1 | 1 | 0 |
| 4 | cola | 1 | 1 | 1 |
| 5 | s | 1 | 1 | 0 |
| 6 | drink | 0 | 0 | 0 |
| 7 | at | 0 | 0 | 0 |
| 8 | at | 1 | 0 | 1 |
| 9 | & | 1 | 0 | 1 |
| 10 | t | 1 | 0 | 0 |
| 11 | at&t | 0 | 0 | 0 |
| 12 | att | 1 | 1 | 0 |

In particular embodiments, a metadata field may also indicate whether part or all of the token was capitalized in the post from which the token is based. In particular embodiments, other types of metadata included in the second fields may include an indication that the token in the first field is associated with an entity of an the online social network, an indication that the token in the first field has been spell-corrected with respect to a n-gram in the content corresponding to the token in the object corresponding to the record, and an indication that the token is associated with a hashtag. Although this disclosure describes providing metadata in a particular manner, this disclosure contemplates providing metadata in any suitable manner.

In particular embodiments, the social-networking system 160 may reconstruct the content of a content object that corresponds to a particular record using the tokens from the first field and the metadata from the one or more second fields. The social-networking system 160 may analyze the tokens and the metadata to reconstruct the content of the content object. The social-networking system 160 may start by filtering out all modified tokens. As an example and not by way of limitation, if the social-networking system 160 were to reconstruct the content from the record in the above table, it may begin by filtering out the tokens that have a “1” in the “is the token modified?” column. This filtering may leave the following tokens: “drinking,” “coca,” “cola's,” “drink,” “at,” “at&t.” In this case, the original content is acquired after the first step. In other cases, the social-networking system 160 may need to perform additional analysis, such as converting letters from uppercase to lowercase or vice versa, adding or removing punctuation, or other suitable alterations. Although this disclosure describes reconstructing the text of a content object in a particular manner, this disclosure contemplates reconstructing the text of a content object in any suitable manner.

In particular embodiments, the social-networking system 160 may store the metadata using a technique called Sparse Vector Compression. In particular embodiments, the tokens and associated metadata in the first field and second fields may be stored as a list of words. Each word may have 64 bits to store information. The most common bits may be stored in the least-significant bit, so that the resulting integer value is small. Varint encoding may be used to compress the integers further by storing the tokens and the associated metadata as strings. To decode and encode the string metadata, the social-networking system 160 may use a technique called Sparse Vector Compression (also referred to as delta encoding, data differencing, and gap encoding). In numerical analysis and computer science, a sparse matrix, sparse vector, or sparse array is a matrix or vector in which most of the elements are zero. By contrast, if most of the elements are nonzero, then the matrix or vector is considered dense. To save computing resources, it may be desirable to design a matrix or vector to be sparse rather than dense. The number of zero-valued elements divided by the total number of elements (e.g., m×n for an m×n matrix) is called the sparsity of the matrix (which is equal to 1 minus the density of the matrix). Sparse vector compression may be accomplished by taking the non-zero valued elements of a vector and storing them as consecutive elements of an associated vector or container, along with information regarding the gap between nonzero elements in the vector. This may result in lower resource allocation and faster processing speeds. In particular embodiments, the metadata associated with each of the tokens may comprise a plurality of zero-valued elements (e.g., 0s), and a plurality of non-zero valued elements (e.g., 1s), wherein consecutive zero-valued elements are stored as a single gap element in association in association with an adjacent non-zero valued element. As an example and not by way of limitation, if a token has a “1” in a particular second field, but then has 29 “0s” in 29 consecutive second fields until the next “1,” instead of listing 29 “0s,” the social-networking system 160 may simply include an additional piece of information (e.g., gap element) in association with the initial “1” that indicates there are 29 “0s” until the next “1.” This may result in lower resource allocation and faster processing speeds. Although this disclosure describes storing metadata information in a particular manner, this disclosure contemplates storing metadata information in any suitable manner.

In particular embodiments, the social-networking system 160 may score each identified object based at least in part on the record that corresponds to the respective identified object. In particular embodiments, the record comprises both the tokens in the first field and one or more types of metadata in the second fields. The score for each identified object may be calculated based on the metadata associated with each of the tokens in the first that match an n-gram of the search query. The social-networking system 160 may identify which tokens match or, in particular embodiments, substantially match the n-grams of the search query. The social-networking system 160 may next analyze the metadata associated with each of the tokens and calculate the score based on particular metadata. In particular embodiments, one of the types of metadata may be an indication that a token in the first field has been modified with respect to an n-gram in the content corresponding to the token in the object corresponding to the record. In this case, scoring each identified token may include, for each of the tokens in the first field that match an n-gram of the search query, increasing the score of the identified object if the token has not been modified and decreasing the score of the identified object if the token has been modified. To accomplish this, the social-networking system 160 may assign weights to tokens based on their associated metadata (e.g., a modified token may be assigned a lower weight than an unmodified token). As an example and not by way of limitation, if a post comprises the text “Played Dogeball at the Rec Center,” the social-networking system 160 may generate two tokens based on the n-gram “dogeball:” the original n-gram “dogeball,” and a spell-corrected version, “dodgeball.” The misspelled “dogeball” token may be assigned a higher weight than the “dodgeball” token. Thus, if a user inputs a search query for “dogeball,” the post that says “Played Dogeball at the Rec Center” may receive a higher score than another similar post that has the word “dodgeball” spelled correctly. Alternatively, the social-networking system 160 may assign weights in reverse: higher weights may be assigned to modified tokens if they are the proper spelling of common words or entities and lower weights may be assigned to unmodified tokens if they are not associated with any common word or popular entity on the online social network. In addition, the social-networking system 160 may take into consideration the number of edges connecting to nodes in a social graph 200 when determining weights for tokens. As an example and not by way of limitation, a post may include the n-gram “Tom Cruz.” There may be an entity named “Tom Cruz” (e.g., a user of the online social network) which has relatively few edge connections compared to the entity “Tom Cruise,” the famous actor. The social-networking system 160 may generate two tokens for the n-gram “Tom Cruz:” the original n-gram “Tom Cruz,” and the modified token “Tom Cruise.” Because the node corresponding to the famous actor “Tom Cruise” likely has many more edge connections than the node corresponding to the user “Tom Cruz,” the social-networking system 160 may assign a heavier weight to the modified Tom Cruise token and a lighter weight to the unmodified Tom Cruise token, since it is likely that a user who searches “Tom Cruz” may be looking for the actor Tom Cruise rather than the user Tom Cruz (unless, of course, Tom Cruz and the querying user have a first-degree connection with one another). In this case, for the query “Tom Cruz,” the social-networking system 160 may assign a higher score to the object with a modified token and a lower score to the object with an unmodified token. Although this disclosure describes scoring identified objects in a particular manner, this disclosure contemplates scoring identified objects in any suitable manner.

In particular embodiments, one of the types of metadata may be an indication whether a modified version of the token has already been listed in the first field. In this case, scoring each identified token may include, for each of the tokens in the first field that match an n-gram of the search query, increasing the score of the identified object if a modified version of the token has not already been listed in the first field, and decreasing the score of the identified object if a modified version of the token has already been listed in the first field. To accomplish this, the social-networking system 160 may assign weights to tokens based on their associated metadata. As an example and not by way of limitation, if a token is the “first version,” then it may receive a heavier weight. Thus, when scoring the corresponding identified object, a search query that matches that token may cause the score of the corresponding identified object to increase. As an example and not by way of limitation, consider the following versions of tokens for the post: “Eating M&M's with my cuz′:”

TABLE 3
Token with Example Metadata

| | | Is the token not |
|---|---|---|
| Pos. | Token | the first version? |
| 0 | Eating | 0 |
| 1 | M&M's | 0 |
| 2 | M&Ms | 0 |
| 3 | M | 1 |
| 4 | & | 1 |
| 5 | M | 1 |
| 6 | s | 1 |
| 7 | with | 0 |
| 8 | my | 0 |
| 9 | cuz' | 0 |
| 10 | cuz | 0 |
| 11 | cousin | 1 |

For all the tokens that have a “1” for this particular metadata type, it may indicate that a modified version of the token has already been listed in the first field. This may be useful because the first modified token may be the most likely to be a match to a particular search query. As an example and not by way of limitation, M&Ms is more likely to match with M&M's than a mere “M.” Thus, if there is a 0 for that token it may mean that a modified version of the token has not already been listed in the first field and may thus receive a heavier weighting. Consequently, the corresponding content object may receive an increasing score. Although this disclosure describes scoring identified objects in a particular manner, this disclosure contemplates scoring identified objects in any suitable manner.

In particular embodiments, one of the types of metadata may be an indication of whether a first token is part of an n-gram that terminates with a second token. In other words, this metadata type may indicate whether a token is part of a term that continues with another token listed in the first field. In this case, scoring each identified token may include, for each of the tokens in the first field that match an n-gram of the search query, increasing the score of the identified object if the token is not a first token that is a part of an n-gram that terminates with a second token and decreasing the score if the token is a first token that is a part of an n-gram that terminates with a second token. To accomplish this, the social-networking system 160 may assign weights to tokens based on their associated metadata. As an example and not by way of limitation, if a token is part of a term that continues with another token, then it may receive a lower weight. If the token is the final token in a term in a post, then it may receive a higher weight. As an example and not by way of limitation, consider the following versions of tokens for the post: “Eating M&M's with my cuz′:”

TABLE 4
Token with Example Metadata

| | | Does the term |
|---|---|---|
| Pos. | Token | continue? |
| 0 | Eating | 0 |
| 1 | M&M's | 0 |
| 2 | M&Ms | 0 |
| 3 | M | 1 |
| 4 | & | 1 |
| 5 | M | 1 |
| 6 | s | 0 |
| 7 | with | 0 |
| 8 | my | 0 |
| 9 | cuz' | 0 |
| 10 | cuz | 0 |
| 11 | cousin | 0 |

For all the tokens that have a “1” for this particular metadata type, it may indicate that the token is part of a term that continues. This may be useful because if the token is part of a term that continues with another token in the first field, the token may be less likely to be an actual match with a search query that includes that token. In the above example, the term M&M's have been separated into four different tokens: “M,” “&,” “M,” and “s.” If a user inputs a search term for “M Jordan,” it is unlikely that the user is indenting to locate the post “Eating M&M's with my cuz′.” Thus, the Ms in positions three and five in the above table may receive a lighter weight, and this content object may receive a lower score. Although this disclosure describes scoring identified objects in a particular manner, this disclosure contemplates scoring identified objects in any suitable manner.

In particular embodiments, the social-networking system 160 may access a social graph 200 when determining the score for each identified content object. The social graph 200 may comprise a plurality of nodes and edges connecting the nodes. Each edge may connect two nodes and may represent a single degree of separation between the two nodes. The nodes may comprise a first node corresponding to a user who inputs a search query (e.g., a querying user). A plurality of second nodes may correspond to a plurality of objects posted to the online social network. These objects may be posted by users or entities of the online social network. The social-networking system 160 may score each identified object based not only on the metadata as discussed above, but also on a degree of separation between the first node corresponding to the querying user and the second node corresponding to the object (i.e., the minimum number of edges needed to create a path between the nodes within the social graph 200). The social-networking system 160 may base the score on degree of separation because a user may be more likely to search for or click on objects that first-degree connections (e.g., friends) or second-degree connections (e.g., friends-of-friends) have posted. As an example and not by way of limitation, a user may input a search query that states: “kite surfing.” If the user's first degree connection has posted a photo that says “Nothing better than kite surfing in Hawaii,” this may be scored higher than a second user's post that says, “Epic Kite Surfing Fails,” if there is no connection between the querying user and the second user. Although this disclosure describes scoring identified objects in a particular manner, this disclosure contemplates scoring identified objects in any suitable manner.

In particular embodiments, the first field may comprise n positions. As an example and not by way of limitation, the first field that corresponds to Table 2 above may comprise 13 positions, ranging from n=0 to n=12. Each position may correspond to each token that has been extracted or generated from the user-inputted content of a corresponding content object. The score for each identified object may be further based on a number of intervening positions between tokens in the first field that match an n-gram of the search query. As an example and not by way of limitation, consider a post with the text: “this is AT&T.” The social-networking system 160 may generate a record for the text in this post that looks like the following (note that metadata is not included for the sake of simplicity):

TABLE 5
Token Position

| Pos. | Token |
|---|---|
| 0 | “this” |
| 1 | “is” |
| 2 | “A” |
| 3 | “T” |
| 4 | “&” |
| 5 | “T” |
| 6 | “ATT” |

If a user inputs a search query for “This is ATT,” the social-networking system 160 may take into account the number of intervening positions between the matching tokens in the record. Continuing with the example, there are four intervening positions between “is” (at position 1) and “ATT” (at position 6). Without metadata, the social-networking system 160 may erroneously score the post “this is AT&T” lower than it should, because of the intervening positions. However, if the social-networking system 160 takes into account particular metadata (e.g., whether a token is part of a term that continues with another term), it may treat the intervening positions appropriately. As an example and not by way of limitation, if the metadata shows that the tokens in positions two through five are all the same term in the original post, the social-networking system 160 may score the content object as if there were only one intervening position between “is” and “ATT.” This may be because the term “AT&T” was broken into four different tokens in the corresponding record. As a result, the social-networking system 160 may increase the score based on a determination from the metadata that at least some of the tokens in intervening positions in the first field are a part of an n-gram that comprises a plurality of tokens in the first field. Although this disclosure describes scoring identified objects in a particular manner, this disclosure contemplates scoring identified objects in any suitable manner.

In particular embodiments, the social-networking system 160 may send, to the client system 130 in response to the received search query, instructions for presenting one or more search results corresponding to one or more of the identified objects. Each of the search results may correspond to an identified object that has a score greater than a threshold score. As an example and not by way of limitation, the objects may be scored on a scale of 0 to 1, and the threshold score may be 0.6. Four of the identified objects may be scored above 0.6 based on the metadata and tokens as described herein. These objects may be sent to the client system 130 of the querying user for display on a display screen of the client system 130. Alternatively, a threshold number of top scoring objects may be presented (e.g., top 3, top 7, etc.). In particular embodiments, the instructions for presenting the search results may comprise instructions for presenting the search results in ranked order based on the score of each of the one or more identified objects. As an example and not by way of limitation, if the four identified objects have a score of 0.61, 0.68, 0.75, and 0.95, respectively, the instructions may comprise instructions to display the objects based on their scores in descending order. Thus, the object with a score of 0.95 may be displayed first or at the top of the display screen, the object with a score of 0.75 may be displayed second, and so on. Although this disclosure describes sending instructions to a client system in a particular manner, this disclosure contemplates sending instructions to a client system in any suitable manner.

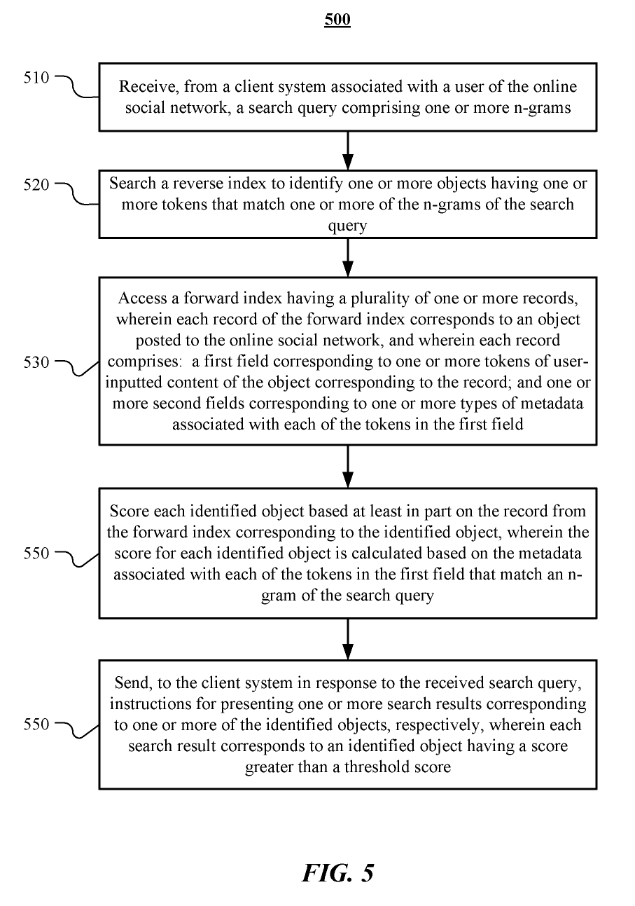

FIG. 5 illustrates an example method 500 for using metadata associated with content posted to the online social network to improve the ranking process for search results. The method may begin at step 510, where the social-networking system 160 may receive, from a client system associated with a user of the online social network, a search query comprising one or more n-grams. At step 520, the social-networking system 160 may search a reverse index to identify one or more objects having one or more tokens that match one or more of the n-grams of the search query. At step 530, the social-networking system 160 may access a forward index having a plurality of one or more records, wherein each record of the forward index corresponds to an object posted to the online social network. Each record may comprise: a first field corresponding to one or more tokens of user-inputted content of the object corresponding to the record; and one or more second fields corresponding to one or more types of metadata associated with each of the tokens in the first field. At step 540, the social-networking system 160 may score each identified object based at least in part on the record from the forward index corresponding to the identified object, wherein the score for each identified object is calculated based on the metadata associated with each of the tokens in the first field that match an n-gram of the search query. At step 550, the social-networking system 160 may send, to the client system in response to the received search query, instructions for presenting one or more search results corresponding to one or more of the identified objects, respectively, wherein each search result corresponds to an identified object having a score greater than a threshold score. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for using metadata associated with content posted to the online social network to improve the ranking process for search results including the particular steps of the method of FIG. 5, this disclosure contemplates any suitable method for using metadata associated with content posted to the online social network to improve the ranking process for search results including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

Systems and Methods

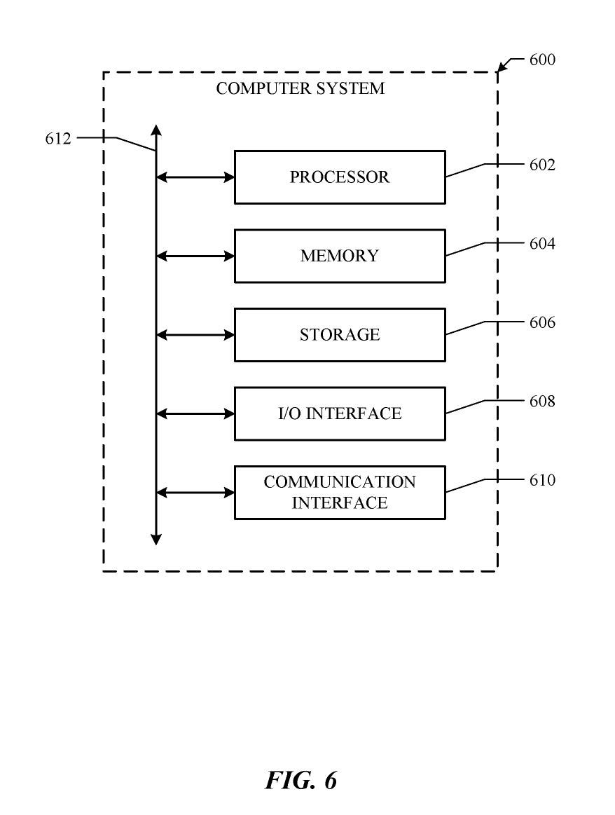

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices of an online social network:
receiving, from a client system associated with a user of the online social network, a search query comprising one or more n-grams;
searching a reverse index to identify one or more objects having one or more tokens that match one or more of the n-grams of the search query;
accessing a forward index having a plurality of records, wherein each record of the forward index corresponds to an object posted to the online social network, and wherein each record comprises:
a first field corresponding to one or more tokens of user-inputted content of the object corresponding to the record; and
one or more second fields corresponding to one or more types of metadata associated with each of the tokens in the first field;
scoring each identified object based at least in part on the record from the forward index corresponding to the identified object, wherein the score for each identified object is calculated based on the metadata associated with each of the tokens in the first field that match an n-gram of the search query; and
sending, to the client system in response to the received search query, instructions for presenting one or more search results corresponding to one or more of the identified objects, respectively, wherein each search result corresponds to an identified object having a score greater than a threshold score.

2. The method of claim 1, wherein, for each record of the forward index, the first field comprises n positions corresponding to n tokens extracted from the user-inputted content of the object corresponding to the record, the n tokens being positioned in positions 1 through n based on an order that n-grams in the content corresponding to the tokens are ordered in the object.

3. The method of claim 2, wherein the one or more second fields each comprise n positions corresponding to the n tokens, respectively.

4. The method of claim 1, wherein the user-inputted content comprises a plurality of n-grams, and wherein the first field comprises a plurality of tokens that match the plurality of n-grams.

5. The method of claim 4, wherein the first field further comprises a modified token that is based on at least one of the plurality of n-grams, wherein the modified token:
is an alternative spelling of the at least one of the plurality of n-grams;
refers to an entity that is associated with the at least one of the plurality of n-grams; or
substantially matches the at least one of the plurality of n-grams but does not comprise punctuation marks.

6. The method of claim 1, wherein the one or more types of metadata comprise one or more of:
an indication that a token in the first field has been modified with respect to a n-gram in the content corresponding to the token in the object corresponding to the record;
an indication, for each token in the first field, that a modified version of the token has already been listed in the first field; or
an indication that a first token is a part of an n-gram that terminates with a second token.

7. The method of claim 1, wherein:
the one or more types of metadata comprise an indication that a token in the first field has been modified with respect to a n-gram in the content corresponding to the token in the object corresponding to the record; and
scoring each identified object comprises, for each of the tokens in the first field that match an n-gram of the search query, increasing the score of the identified object if the token has not been modified and decreasing the score of the identified object if the token has been modified.

8. The method of claim 1, wherein:
the one or more types of metadata comprise an indication, for each token in the first field, that a modified version of the token has already been listed in the first field; and
scoring each identified object comprises, for each of the tokens in the first field that match an n-gram of the search query, increasing the score of the identified object if a modified version of the token has not already been listed in the first field, and decreasing the score of the identified object if a modified version of the token has already been listed in the first field.

9. The method of claim 1, wherein:
the one or more types of metadata comprise an indication that a first token is a part of an n-gram that terminates with a second token; and
scoring each identified object comprises, for each of the tokens in the first field that match an n-gram of the search query, increasing the score of the identified object if the token is not a first token that is a part of an n-gram that terminates with a second token and decreasing the score if the token is a first token that is a part of an n-gram that terminates with a second token.

10. The method of claim 1, further comprising reconstructing the content of the object corresponding to a particular record using the tokens from the first field of the record and one or more types of metadata associated with each of the tokens from one or more of the second fields.

11. The method of claim 1, wherein the one or more types of metadata associated with each of the tokens comprises a plurality of zero-valued elements and a plurality of non-zero-valued elements, wherein consecutive zero-valued elements are stored as a single gap element in association with an adjacent non-zero-valued element.

12. The method of claim 1, wherein the search query comprises a misspelled word and one of the tokens in the first field is a modified token that comprises a correct spelling of the misspelled word.

13. The method of claim 1, wherein:
for each record of the forward index, the first field comprises n positions corresponding to n tokens extracted from the user-inputted content of the object corresponding to the record; and
scoring each identified object is further based on a number of intervening positions between tokens in the first field that match an n-gram of the search query.

14. The method of claim 13, wherein the score decreases as the number of intervening positions increases.

15. The method of claim 13, further comprising increasing the score based on a determination, from the one or more types of metadata, that at least some of the tokens in intervening positions in the first field are a part of an n-gram that comprises a plurality of tokens in the first field.

16. The method of claim 1, wherein the one or more types of metadata comprise one or more of:
an indication that the token in the first field is associated with an entity of the online social network;
an indication that the token in the first field has been spell-corrected with respect to a n-gram in the content corresponding to the token in the object corresponding to the record; or
an indication that the token is associated with a hashtag.

17. The method of claim 1, wherein the instructions for presenting one or more search results corresponding to one or more of the identified objects comprises instructions for presenting the one or more search results in ranked order based on the score of each of the one or more identified objects.

18. The method of claim 1, further comprising:
accessing a social graph comprising a plurality of nodes and a plurality of edges connecting the nodes, each of the edges between two of the nodes representing a single degree of separation between them, the nodes comprising:
a first node corresponding to the user; and
a plurality of second nodes corresponding to a plurality of objects posted to the online social network and wherein:
scoring each identified object is further based on a degree of separation between the first node and the second node corresponding to the object.

19. One or more computer-readable non-transitory storage media embodying software that is operable when executed to:
receive, from a client system associated with a user of the online social network, a search query comprising one or more n-grams;
search a reverse index to identify one or more objects having one or more tokens that match one or more of the n-grams of the search query;
access a forward index having a plurality of records, wherein each record of the forward index corresponds to an object posted to the online social network, and wherein each record comprises:
a first field corresponding to one or more tokens of user-inputted content of the object corresponding to the record; and
one or more second fields corresponding to one or more types of metadata associated with each of the tokens in the first field;
score each identified object based at least in part on the record from the forward index corresponding to the identified object, wherein the score for each identified object is calculated based on the metadata associated with each of the tokens in the first field that match an n-gram of the search query; and
send, to the client system in response to the received search query, instructions for presenting one or more search results corresponding to one or more of the identified objects, respectively, wherein each search result corresponds to an identified object having a score greater than a threshold score.

20. A system comprising: one or more processors; and a non-transitory memory coupled to the processors comprising instructions executable by the processors, the processors operable when executing the instructions to:
receive, from a client system associated with a user of the online social network, a search query comprising one or more n-grams;
search a reverse index to identify one or more objects having one or more tokens that match one or more of the n-grams of the search query;
access a forward index having a plurality of records, wherein each record of the forward index corresponds to an object posted to the online social network, and wherein each record comprises:
a first field corresponding to one or more tokens of user-inputted content of the object corresponding to the record; and
one or more second fields corresponding to one or more types of metadata associated with each of the tokens in the first field;
score each identified object based at least in part on the record from the forward index corresponding to the identified object, wherein the score for each identified object is calculated based on the metadata associated with each of the tokens in the first field that match an n-gram of the search query; and
send, to the client system in response to the received search query, instructions for presenting one or more search results corresponding to one or more of the identified objects, respectively, wherein each search result corresponds to an identified object having a score greater than a threshold score.
